(19) United States
(12) Patent Application Publication
(10) Pub. No.: US 2012/0287054 A1
(43) Pub. Date: Nov. 15, 2012

(54) TOUCH POSITION DETECTING METHOD

(75) Inventors: Chin Hua Kuo, Pingtung City (TW); R-Ming Hsu, Zhongli City (TW)

(73) Assignee: SILICON INTEGRATED SYSTEMS CORP., Hsinchu City (TW)

(21) Appl. No.: 13/105,172

(22) Filed: May 11, 2011

(51) Int. Cl. G06F 3/041

(52) U.S. Cl. 345/173

(57) ABSTRACT

A touch position detecting method for a touch screen is disclosed. In the method, a specific point is detected by comparing a sensed data thereof with a first threshold and by comparing a sum of sensed values of a group of points which include the specific point with a second threshold. Furthermore, the sensed value of the specific point is checked to see if it is the maximum among the group of points. By using such a method, accuracy of touch position detection can be improved.

### TECHNICAL FIELD OF THE INVENTION

The present invention relates to touch sensing technique, more particularly, to a method for accurately detecting and determining positions of touches on a touch screen.

### BACKGROUND OF THE INVENTION

Nowadays, touch sensitive devices are widely used in various applications. Amongst, a touch screen comprising a touch panel is very popular.

As known, the touch screen has a matrix of points on the screen to receive a touch or touches from a finger or any other suitable object. Each of the points corresponds to a pixel. A sensing circuit senses data from the points and determines which one or ones of the points are touched.

To achieve various functions, a position or positions of one or more touches occurred on the touch screen need to be accurately detected. However, erroneous determination is likely to happen due to various noises.

Therefore, there is a need for a solution to accurately detect positions of touches occurring on the touch screen or the like.

### SUMMARY OF THE INVENTION

An objective of the present invention is to provide a touch position detecting method, by which positions of touches on a touch screen can be accurately detected.

In accordance with an aspect of the present invention, a touch position detecting method for a touch screen comprises sensing each point of the touch screen to obtain a sensed value; determining whether a target point of the points is effective according to the sensed value thereof; comparing the sensed value of the target point with a first threshold if the target point is effective; summing sensed values of the target point and a plurality of surrounding points around the target point to obtain a sensed value sum if the sensed value of the target point exceeds the first threshold; and comparing the sensed value sum with a second threshold, wherein the target point is determined as being touched if the sensed value sum exceeds the second threshold.

In another aspect of the present invention, the sensed value of the target point can be eliminated in the step of summing the sensed values of the points.

In a further aspect of the present invention, the touch position detecting method further comprises determining whether the target point has a maximum sensed value among a group of points including the target point and the surrounding points. The target point is determined as being touched if the sensed value sum exceeds the second threshold and the target point has the maximum sensed value among the group of points

In still a further aspect of the present invention, a touch position detecting method for a touch screen comprises reading data of each point; determining whether a target point of the points is effective according to a value of the data thereof; comparing the value of the data of the target point with a first threshold if the target point is effective; comparing a total value of the data of a group of points including the target point with a second threshold if the value of the data of the target point exceeds the first threshold. The group of points comprise a predetermined number of points including the target number. The target point is determined as being touched if the total value of the data of the group of points exceeds the second threshold.

### BRIEF DESCRIPTION OF THE DRAWINGS

The present invention will be described in detail in conjunction with the appending drawings, in which:

FIG. 1 is an illustration schematically showing touches on a touch screen;

FIG. 2 is an illustration schematically showing effective sensed points on a touch screen;

FIG. 3 is an illustration schematically showing which ones of the effective sensed points have sufficiently high sensed values;

FIG. 4 is an illustration schematically showing candidate touched points which are determined by using a first threshold;

FIG. 5 is an illustration schematically showing verified touched points; and

FIG. 6 is a flow chart showing a method in accordance with an embodiment of the present invention.

### DETAILED DESCRIPTION OF THE INVENTION

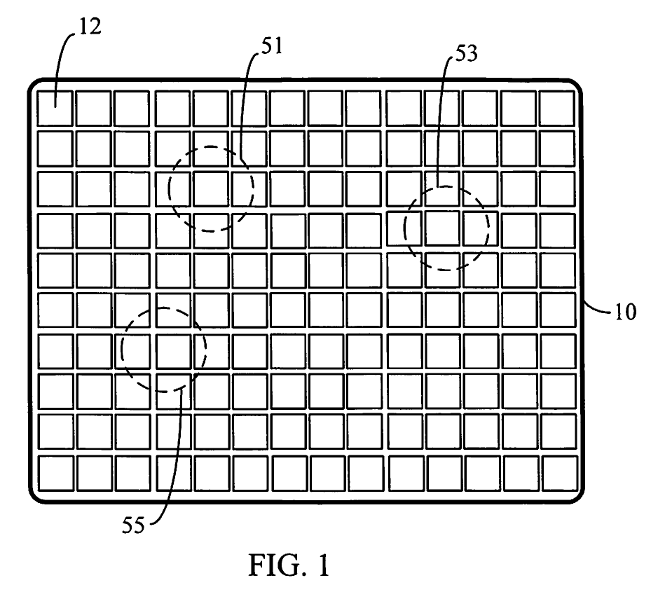

FIG. 1 is an illustration schematically showing touches on a touch screen 10. The touch screen 10 has a matrix of points 12, and each point 12 corresponds to a pixel. In this example, it is assumed that there are three locations 51, 53, 55 are touched, which are marked by dashed circles, as shown in the drawing.

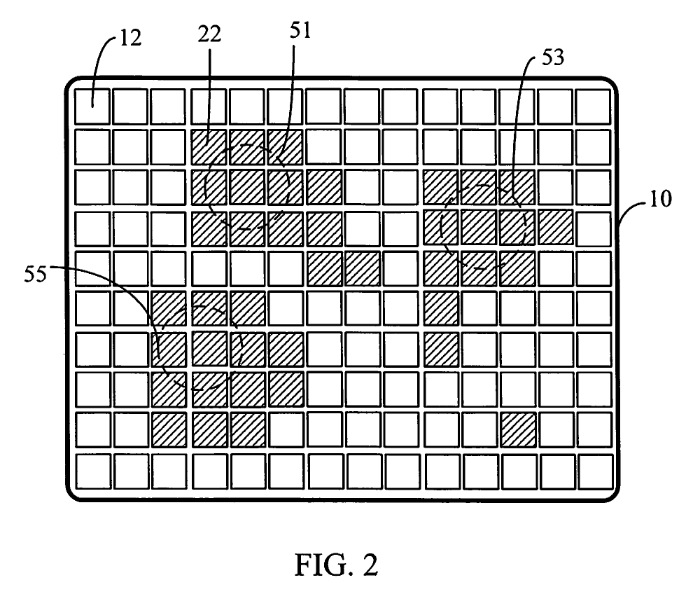

After all of the points 12 of the touch screen 10 are scanned and sensed, a sensing circuit (not shown) determines that some of the points have significant changes (e.g. capacitance change). The points with significant changes are referred to as “effective sensed points 22” here to be distinguishable from the points 12 without sufficiently significant change. FIG. 2 is an illustration schematically showing the effective sensed points 22 of the touch screen 10. In the drawing, the effective sensed points 22 are shaded. However, as mentioned above, due to the existence of noises, it is possible that some of the effective sensed points 22 are not touched in fact.

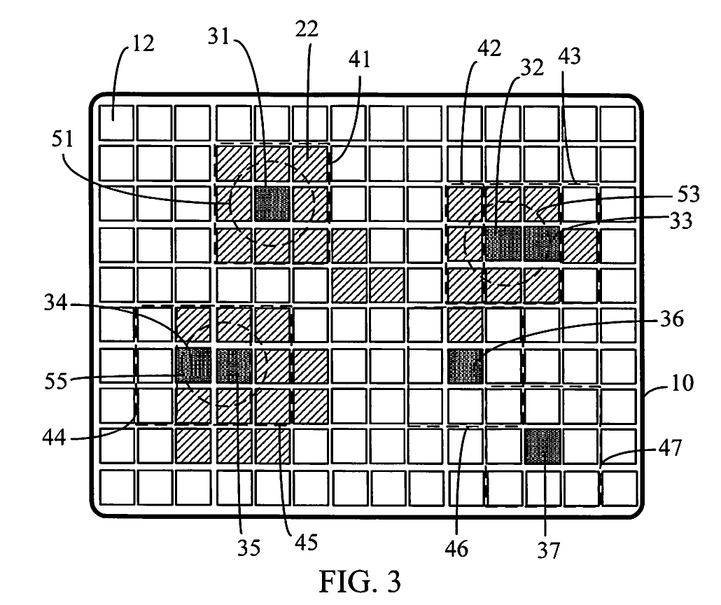

In an embodiment of the present invention, each of the effective sensed points 22 is checked. The sensed value DP (e.g. a capacitance) of each effective sensed point 22 is compared with a first threshold TH1 so as to eliminate the “fake” sensed points. FIG. 3 is an illustration schematically showing which ones of the effective sensed points 22 have sufficiently high sensed values. As shown, the dark points 31, 32, 33, 34, 35, 36 and 37 are the points having the sufficiently high sensed values. That is, each of the points 31, 32, 33, 34, 35, 36 and 37 has a sensed value DP higher than the first threshold TH1. For the sake of descriptive convenience, these points 31, 32, 33, 34, 35, 36 and 37 are referred to as “candidate touched points”.

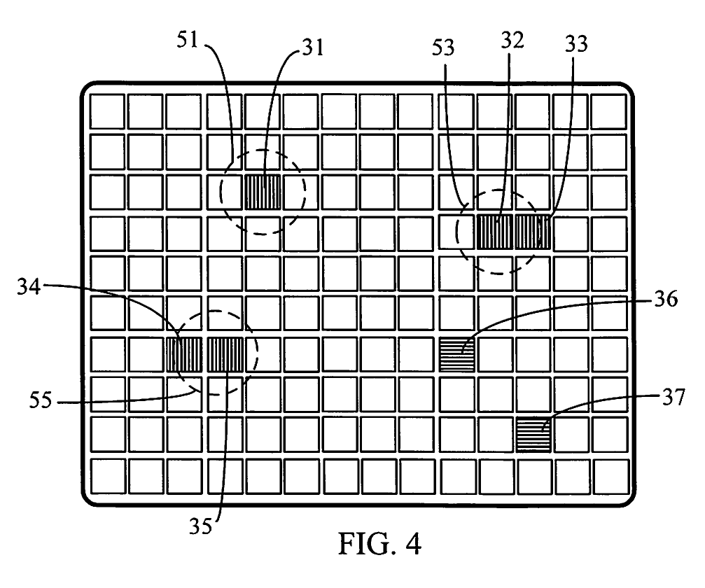

The effective sensed points 22 other than the candidate touches points are then eliminated as shown in FIG. 4, which is an illustration schematically showing candidate touched points 31, 32, 33, 34, 35, 36 and 37. As described, the candidate touched points 31, 32, 33, 34, 35, 36 and 37 are determined by comparing with the first threshold TH1. Among these candidate touched points 31, 32, 33, 34, 35, 36 and 37, the points 31, 32, 33, 34 and 35 are “true touched points”, while the points 36 and 37 are “false touched points”. The points 36 and 37 are not actually touched but have sufficiently high sensed values due to noises such as surges or spikes. However, it is not possible to distinguish the true touched points from the false touched points by using only the first threshold TH1. Accordingly, a further check is required. In the present embodiment, a 3×3 block with a candidate touched point at the center is checked.

Returning back to FIG. 3, for each of the candidate touched points 31, 32, 33, 34, 35, 36 and 37, a group of points including the candidate touched point per se and other points are checked. In the present embodiment, a 3×3 block including each candidate touched point at the center and eight surrounding points around the candidate touched point is checked as a unit at this stage. The sensed values DPs of the nine points are summed and compared with a second threshold TH2. For example, a block 41 is defined to include the candidate touched point 31 at the center and eight surrounding points around the candidate touched point 31. The candidate touched point 31 has a sensed value DP higher than the first threshold TH1. In addition, as can be seen from the drawing, the eight surrounding points in this block 41 are all effective sensed points 22. That is, each of the eight surrounding points in this block 41 at least has a basic sensed value. As a result, the sum of the sensed values of the nine points including the eight surrounding points and the central candidate touched point 31 will be sufficiently high to exceed the second threshold TH2. In the present embodiment, the second threshold TH2 is properly predetermined so that it is suitable to be used to check the 3×3 block including the candidate touched point at the center and eight surrounding points around the candidate touched point. However, it is also possible to check only the eight surrounding points excluding the central candidate touched point. Under such a circumstance, the second threshold TH2 should be set to be lower. Furthermore, other sizes of blocks are also possible. For example, a 5×5 block including the candidate touched point at the center and 24 surrounding points around the candidate touched point can be utilized as a unit of checking.

As shown in FIG. 3, the blocks 41, 42, 43, 44, 45, 46 and 47 respectively having the candidate touched points 31, 32, 33, 34, 35, 36 and 37 at the centers are checked by comparing the sensed value sum of each block with the second threshold TH2. The comparison results indicate that the sensed value sum of each of the blocks 41, 42, 43, 44, 45 exceeds the second threshold TH2, while the sensed value sum of each of the blocks 46, 47 is lower than the second threshold TH2. Accordingly, the candidate touched points 31, 32, 33, 34, 35 are determined as true touched points; while the candidate touched points 36 and 37 are determined as false touched points, as shown in FIG. 4.

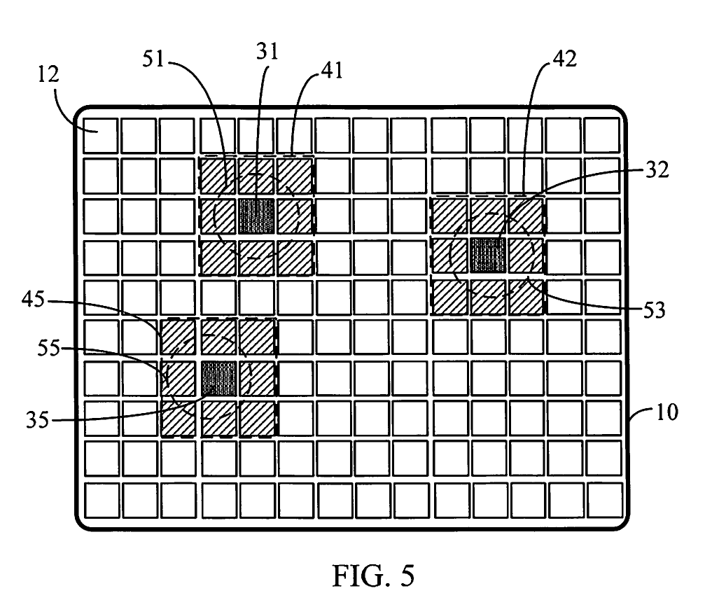

In the present embodiment, in order to improve accuracy of touch position detection, each of the true touched points 31, 32, 33, 34, 35 is further verified by checking if it is a centroid of the block. Please refer to FIG. 5 in conjunction with FIGS. 3 and 4, each of the true touched points 31, 32, 33, 34, 35 is examined to determine if the sensed value DP of the true touched point is the maximum of the relevant block. For example, the true touched point 31 is examined to determine if its sensed value DP is the maximum among the points in the block 41. The rest can be deduced accordingly. By doing so, the true touched points 33 and 34 are eliminated since these two points do not satisfy such a condition. The true touched points 31, 32 and 35, which pass the centroid examination, can be referred to as “verified touched points”. FIG. 5 shows verified touched points determined in the present embodiment. As described, the verified touched point 31 has the maximum sensed value DP among the nine points of the block 41. In addition, the verified touched point 32 has the maximum sensed value DP among the nine points of the block 42. The verified touched point 35 has the maximum sensed value DP among the nine points of the block 45.

As described, each of the verified touched points satisfies three conditions. First, the sensed value DP of each verified touched point should exceed the first threshold TH1. Second, the sum of the sensed values of the block embracing the verified touched point should exceed the second threshold TH2. Third, the sensed value DP of the verified touched point should be the maximum among the points of the block embracing the verified touched point.

After the verified touched points are determined, coordinates of a sub-pixel order can be calculated from the sensed values of the points in the blocks by using an algorithm such as interpolation (e.g. linear interpolation or bi-linear interpolation) or the like. Please refer to FIG. 5, for example, the sensed value DP of the verified touched point 35 and the sensed values of the surrounding points around the verified touched point 35 in the block 45 are all known. A very precise coordinate of an order of sub-pixel can be obtained by interpolating these sensed values.

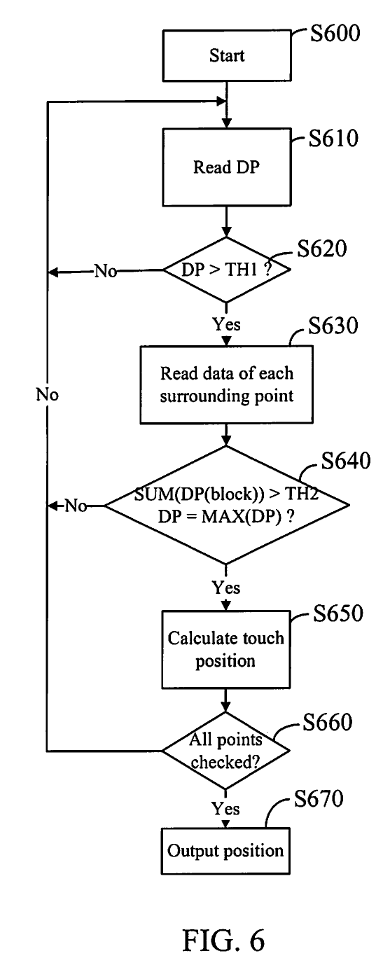

To more clarify the implementations of the present invention, the embodiment of the present invention will be further described in detail with reference to FIG. 6, which is flow chart of the touch position detecting method in accordance with the embodiment of the present invention. The process starts at step S600. In step S610, data such as a sensed value DP of an effective sensed point 22, which can be referred to as a target point, is read. In step S620, the sensed value DP is compared with the first threshold TH1 to determine whether the sensed value DP of this effective sensed point 22 exceeds the first threshold TH1. If not, the process goes back to S610 to check another effective sensed point 22. If the sensed value DP exceeds the first threshold TH1, then the target point is determined as a candidate touched point, and the process goes to step S630 to read data (e.g. sensed data) of each surrounding point of the same block. As described above, the block is preferably a matrix of points includes the candidate touched point at the center and a multiple of surrounding points around the candidate touched point. For a 3×3 block, there is one candidate touched point at the center and eight surrounding points around the central candidate touched point. In step S640, it is determined whether a sum of the sensed data of all points of the block DP(block) exceeds the second threshold TH2. As mentioned above, in another embodiment, the sensed value DP of the candidate touched point can be eliminated from the sensed value sum of block DP(block). If the sensed value DP of the candidate touched point is not included, the second threshold TH2 should be set lower. In addition, it is determined whether the candidate touched point has the maximum sensed value DP among all the points of the block in step S640. It is noted that there is no specific executing sequence for the two determinations in step S640. If the result of either one of the two determinations in step S640 is “No”, then the process returns back to step S610 to check another effective sensed point 22 (i.e. a new target point). If the results of both of the two determinations in step S640 are “Yes”, it means that this candidate touched point is true and is verified. That is, this point is determined as a verified touch position. The process goes to step S650 to calculate the coordinate by using the sensed values of the verified touched point and the surrounding points as described above. In step S660, it is determined whether all points have been checked. If so, the position data such as coordinates are outputted in step S670.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

1. A touch position detecting method for a touch screen, said touch screen comprising a matrix of points, said method comprising:
sensing each of the points to obtain a sensed value;
determining whether a target point of the points is effective according to the sensed value thereof;
comparing the sensed value of the target point with a first threshold if the target point is effective;
summing sensed values of the target point and a plurality of surrounding points around the target point to obtain a sensed value sum if the sensed value of the target point exceeds the first threshold; and
comparing the sensed value sum with a second threshold,
wherein the target point is determined as being touched if the sensed value sum exceeds the second threshold.

2. The method as claimed in claim 1, further comprising:
determining whether the sensed value of the target point is the maximum among a group of points including the target point and the surrounding points,
wherein the target point is determined as being touched if the sensed value sum exceeds the second threshold and the target point has the maximum sensed value among the group of points.

3. The method as claimed in claim 1, wherein the surrounding points and the target point consist a block, the target point is at a center of the block.

4. The method as claimed in claim 3, wherein the block comprises a 3×3 matrix of points including the target point at the center and eight surrounding points around the target point.

5. The method as claimed in claim 3, wherein the block comprises a 5×5 matrix of points including the target point at the center and twenty-four surrounding points around the target point.

6. The method as claimed in claim 1, further comprising:
calculating a coordinate by using the sensed value of the target point which is determined as being touched and the sensed values of the surrounding points around the target point.

7. The method as claimed in claim 6, wherein the calculation is operated by using interpolation.

8. A touch position detecting method for a touch screen, said touch screen comprising a matrix of points, said method comprising:
sensing each of the points to obtain a sensed value;
determining whether a target point of the points is effective according to the sensed value thereof;
comparing the sensed value of the target point with a first threshold if the target point is effective;
summing sensed values of a plurality of surrounding points around the target point to obtain a sensed value sum if the sensed value of the target point exceeds the first threshold; and
comparing the sensed value sum with a second threshold,
wherein the target point is determined as being touched if the sensed value sum exceeds the second threshold.

9. The method as claimed in claim 8, further comprising:
determining whether the sensed value of the target point is higher than that of any one of the surrounding points,
wherein the target point is determined as being touched if the sensed value sum exceeds the second threshold and the sensed value of the target point is higher than that of any one of the surrounding points.

10. The method as claimed in claim 8, wherein the surrounding points and the target point consist a block, the target point is at a center of the block.

11. The method as claimed in claim 10, wherein the block comprises a 3×3 matrix of points including the target point at the center and eight surrounding points around the target point.

12. The method as claimed in claim 10, wherein the block comprises a 5×5 matrix of points including the target point at the center and twenty-four surrounding points around the target point.

13. The method as claimed in claim 8, further comprising:
calculating a coordinate by using the sensed value of the target point which is determined as being touched and the sensed values of the surrounding points around the target point.

14. The method as claimed in claim 13, wherein the calculation is operated by using interpolation.

15. A touch position detecting method for a touch screen, said touch screen comprising a matrix of points, said method comprising:
reading data of each point;
determining whether a target point of the points is effective according to a value of the data thereof;
comparing the value of the data of the target point with a first threshold if the target point is effective;
comparing a total value of the data of a group of points including the target point with a second threshold if the value of the data of the target point exceeds the first threshold,
wherein the group of points comprise a predetermined number of points including the target number, and the target point is determined as being touched if the total value of the data of the group of points exceeds the second threshold.

16. The method as claimed in claim 15, further comprising:
determining whether the value of the data of the target point is maximum among the group of points,
wherein the target point is determined as being touched if the total value of the data of the group of points exceeds the second threshold and the value of the data of the target point is the maximum among the group of points.
